(19) United States
(12) Patent Application Publication
(10) Pub. No.: US 2018/0126327 A1
(43) Pub. Date: May 10, 2018

(54) Method and a Device for Cleaning a Gas

(71) Applicant: Hermanus Johannus Theodorus Maria Taris, Den Andel (NL)

(72) Inventor: Hermanus Johannus Theodorus Maria Taris, Den Andel (NL)

(21) Appl. No.: 15/864,808

(22) Filed: Jan. 8, 2018

Related U.S. Application Data
(63) Continuation of application No. PCT/NL2016/050487, filed on Jul. 6, 2016.

(30) Foreign Application Priority Data
Jul. 6, 2015 (NL) 2015097

(51) Int. Cl. B01D 53/18; B01D 53/14

(52) U.S. Cl. CPC B01D 53/185; B01D 2252/103; B01D 53/1481; B01D 53/1493

(57) ABSTRACT

The invention relates to a method for cleaning a gas, comprising the step of guiding said gas to be cleaned through a supply line and contacting said gas with a liquid and a step of injecting the liquid into the gas flow under pressure over a complete flow area of said supply line. The method is characterized in that the gas to be cleaned is fed into the gas cleaning compartment from a gas supply line, said gas cleaning compartment having a peripheral wall, and in that the gas cleaning compartment at a downstream position of the gas supply line is provided with at least one injection nozzle provided in the peripheral wall for injecting the liquid into the gas cleaning compartment and against an opposite wall part, said method further comprising the step of discharging the liquid and the contaminants contained therein via the wall of the gas cleaning compartment. The invention also relates to a device for performing the method.

### CROSS-REFERENCE TO RELATED APPLICATIONS

This application is a continuation application of Patent Cooperation Treaty Application No. PCT/NL2016/050487, filed on Jul. 6, 2016, which claims priority to Netherlands Patent Application No. 2015097, filed Jul. 6, 2015, and the specifications and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### STATEMENT REGARDING PRIOR DISCLOSURES BY THE INVENTOR OR A JOINT INVENTOR

Not Applicable.

### COPYRIGHTED MATERIAL

Not Applicable.

### BACKGROUND OF THE INVENTION

The present invention relates to a method for cleaning gases according to the preamble of claim 1. The invention also relates to a device as described in the claims.

Such a method is known in the art. For example, gasses are cleaned in cooling towers wherein water flows downwards from a rim at an upper edge of the tower, mainly as a water fall, and wherein gas to be cooled and cleaned is guided through said water flow. As a consequence, the gas is cooled and contaminations are removed from the gas.

Such a method is relatively inefficient. Due to the overflow edge at the top side of the cooling tower an impermeable wall of water is obtained that breaks up in relatively large droplets. The true contacting surface of the water therefore is limited. Such a method is only applicable in circumstances where a high cooling tower can be built. The use in a small gas line of only 200 cm in diameter or smaller is not possible. The use of cooling devices that apply a liquid in non-vertical conduits is not possible at all with techniques presently available in the art.

Therefore, there is a need in the art for an improved method and device for cleaning gasses.

### BRIEF SUMMARY OF THE INVENTION

The invention relates to an improved method and device of the kind mentioned in the preamble.

The invention especially aims at providing a method and a device of the kind mentioned in the preamble that is also applicable in other conduits and lines than exactly vertical conduits and line.

The invention also aims at providing a method and device for cleaning gasses without installing obstructions in the flow path of the gas flow.

As a matter of fact, it is known in the art that the amount of liquid for cleaning gasses is relatively large. The invention therefore also aims at providing an improved method and device that provides an efficient cleaning of gasses with a limited amount of liquid. An advantage of a limited amount of liquid is that cooling of the gasses is limited which is especially advantageous in specific circumstances, as is clear to a skilled person after reading this description.

So as to obtain at least one of the aforementioned aims and advantages, according to a first embodiment the invention provides a method comprising the features of claim 1. This method has the advantage that it can be applied in conduits that are placed in any position. The conduit may even be positioned vertically or diagonally.

The invention therefore relates to a method for cleaning a gas, comprising the step of guiding said gas to be cleaned through a gas cleaning compartment and contacting said gas with a liquid, the method comprising the further step of injecting the liquid into the gas flow under pressure over a complete flow area of said gas cleaning compartment for capturing contaminants from said gas flow; the method being characterized in that the gas to be cleaned is fed into the gas cleaning compartment from a gas supply line, said gas cleaning compartment having a peripheral wall, and in that the gas cleaning compartment at a downstream position of the gas supply line is provided with at least one injection nozzle provided in the peripheral wall for injecting the liquid into the gas cleaning compartment and against an opposite wall part, said method further comprising the step of discharging the liquid and the contaminants contained therein via the wall of the gas cleaning compartment.

It has also shown that the invention provides a smaller cooling of the gasses. This is of importance for gasses that are used for heating purposes and wherein heat loss leads to high heating costs due to the need of re-heating of gasses. Such synergetic affect is a great advantage in the present invention.

It is especially preferred that the method comprises the step of injecting the liquid through a slit-shaped nozzle. As a result, a substantially flat liquid jet is obtained such that a large surface area of the gas flow is covered. As a matter of fact, it is especially preferred that the plane of the slit-shaped nozzle is substantially perpendicular to the direction of the gas flow, that is substantially in the same plane as, or parallel to, the flow are of the gas cleaning compartment, so as to obtain a most efficient covering of the gas cleaning compartment.

Due to the positioning of the nozzle in the gas cleaning compartment, not the complete flow area of the gas cleaning compartment may be covered with liquid. In that case it is preferred that the method comprises the step of injecting the liquid through at least two nozzles that are divided along the circumference of the wall of the gas cleaning compartment. Preferably, three or even more nozzles may be used that are evenly distributed along the wall, for reaching at an optimum coverage of the flow area, or that are positioned such that a complete coverage of the flow area of the gas cleaning compartment is obtained. More in particular, preference is given to an embodiment wherein at least two nozzles are positioned evenly along the circumference of the wall of the gas cleaning compartment.

So as to obtain a further enhanced cleaning of the gasses, as well as an optimum coverage of the flow area, it is preferred that the method comprises the step of injecting the liquid in at least two layers that substantially completely cover the full flow area of the gas cleaning compartment, for substantially completely covering the complete flow area and for contacting all gas with the liquid.

Analogous to the explanation above, it is also preferred when applying multiple layers of liquid spray, i.e. multiple layers of nozzles, that each layer comprises at least one nozzle, preferably at least two nozzles, more preferably at least three nozzles.

A simple and cost-effective method is obtained by a method wherein the liquid comprises water. It has shown that even solid material that do not dissolve in water or that are substantially incompatible with water, like soot particles, can be effectively removed from the gas flow when water is used as a liquid. Even the addition of surface active agents is not required. Such is a surprise since the state of the art prescribes the use of additives and the like to remove incompatible substances from a gas flow. The reason for this behavior is not clear but probably due to the high forces that are obtained when spraying the water through the gas flow.

A very simple and efficient embodiment of the method is obtained when it is performed by means of steps wherein the conduit, or the line, is comprised of a gas supply line with a first diameter for supplying the gas to be cleaned, said gas supply line debouching into a gas cleaning compartment that is provided with a nozzle for injecting into the gas cleaning compartment a liquid, said gas cleaning compartment comprising a wall that extends at least radially outside the gas supply line, and therefore has a second diameter that is larger than the first diameter. The liquid that is injected from the nozzle will touch the said wall and flow away along said wall. Since the wall is positioned outside the circumference of the gas supply line the liquid will be allowed to flow away freely.

The invention therefore also relates to a method wherein the gas supply line has a first diameter and the gas cleaning compartment has a second diameter, wherein the second diameter is larger than the first diameter.

The invention also relates to such method comprising the step of vertically in an upward direction feeding the gas to be cleaned through the gas cleaning compartment.

A simple embodiment is obtained by means of a method that comprises the steps of supplying in a vertical direction and upwardly the gas to be cleaned through the gas supply line and injecting the liquid into the gas cleaning compartment for contacting the gas flow with the liquid and removing the liquid along the wall of the gas cleaning compartment. The liquid can easily flow away along the wall of the gas supply line, since that wall may extend to a position lower than and outside of the gas supply line such that the liquid can be collected at or be removed from a position outside the gas supply line.

Surprisingly, the method can be implemented in a method, and in a corresponding device, comprising the step of feeding the gas to be cleaned through the gas supply line in a direction other than a vertical direction, for example a substantially horizontal or diagonal direction, and injecting the liquid into the gas cleaning compartment for contacting the gas flow with the liquid and discharging the liquid via the wall of the gas cleaning compartment. Here also, the liquid will flow away along the wall after it has contacted said wall, and be collected at a collection spot or be removed therefrom.

As mentioned above, it is preferred that the liquid is injected against a wall of the gas cleaning compartment. On the one hand, such provides for a sufficient strong liquid jet ensuring that the liquid trajectory covers a substantially flat plane. On the other hand, such eases collection of the liquid.

The invention further relates to a method wherein part of the gas supply line that is positioned inside the gas cleaning compartment as well as the gas cleaning compartment itself are coaxial tubular shapes. The liquid that has contacted the gas to be cleaned and has removed contaminations therefrom is then discharged via an interstitial space between said coaxial tubular shapes.

According to a further aspect, the invention relates to a device for performing the method according to the invention. The device comprises a gas supply line or a connection device for connecting thereto a gas supply line, the device comprising a gas cleaning compartment with a gas supply line for feeding a gas to be cleaned into the gas cleaning compartment, said gas cleaning compartment being provided with at least one nozzle for injecting into the gas cleaning compartment a liquid for contacting the gas to be cleaned with the liquid, wherein the device further comprises a discharge for discharging the injected liquid. The preferred embodiments as have been described with reference to the method according to the invention are analogously implementable in the device. Analogous results and advantages are obtained.

It is especially preferred that the gas supply line for feeding the gas to be cleaned, or the connection device for connecting thereto a gas supply line, has a first diameter, said gas supply line debouching into a gas cleaning compartment with a second diameter, said second diameter being larger than the first diameter, and wherein the device is provided with a nozzle for injecting into the gas cleaning compartment a liquid, wherein the gas cleaning compartment has a wall that extends at least radially outside the gas supply line.

In the present invention, use is made of terms like “gas conduit”, “gas cline”, “gas supply line” en “line” or “conduit”, wherein in all case a conduit is meant for supplying a gas to be cleaned to the gas cleaning compartment. It may be a circular or any other conduit with any shape. A characterizing feature of the cleaning device, as the case may be, is that the walls of the device extend radially outside the inner diameter of the gas conduit such that water that flows along the said wall of the gas cleaning compartment does not enter the gas conduit and may be removed easily and efficiently.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The invention will now be described by means of a drawing. The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 a schematic sectional view of a device according an embodiment of the present invention; and

FIG. 2 a schematic top view of a device according to an embodiment of the present invention.

### DETAILED DESCRIPTION OF THE INVENTION

In the drawings the same parts are referred to by the same reference numerals. However, for ease of understanding the drawing, not all parts that are required for a practical embodiment are shown in the drawing.

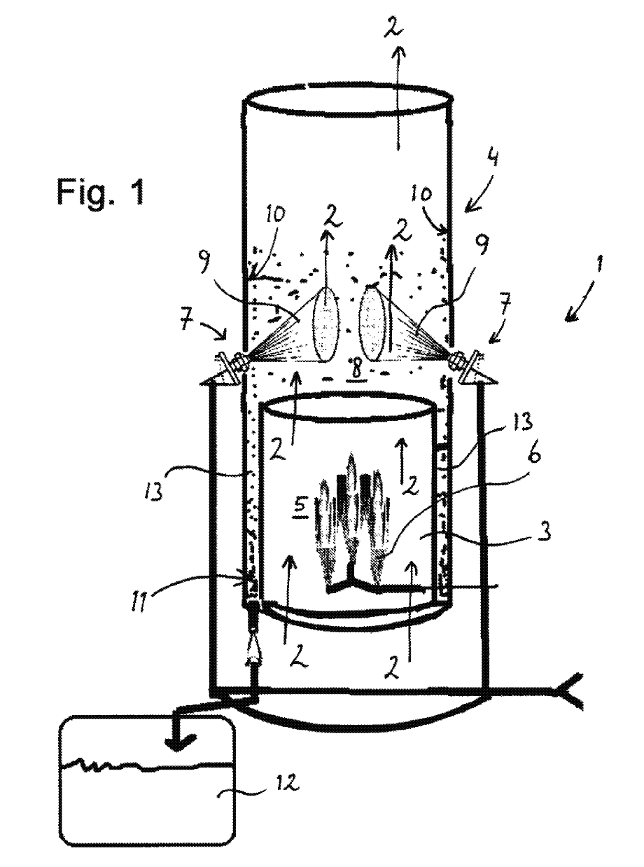

FIG. 1 shows a schematic view of a device 1 for cleaning a gas flow 2. The gas flow 2 is schematically identified by a series or arrows that show a flow direction. The device is comprised of a gas supply line 3 and a gas cleaning compartment 4. In the embodiment as shown in FIG. 1 the gas supply line 3 is shown as a conduit that originates from a burner space 5 with a number of burner nozzles 6 yielding a combustion gas as gas flow 2 containing harmful substances that must be removed from the gas flow 2 in the gas cleaning compartment 4. The gas flow 2 is not limited to such origin but may be obtained from many different sources. It may be obtained from residential areas of a hospital where harmful bacteria and viruses reside in the gas flow 2 and that need to be removed. The gas flow 2 also may originate from factories, farm houses or offices, where the gas flow 2 may comprise dust or fine dust that needs to be removed.

The gas flow 2 is fed from the gas supply line 3 into space 8 in which nozzles 7 are provided for injecting into the space a liquid 9. Through the nozzles 7 a liquid 9 is injected into space 8 of the gas cleaning compartment 4 forcefully. As a consequence, the gas flow 2 is contacted intimately with the liquid 9. The liquid 9 is preferably injected into space 8 in a flat plane, wherein the flat plane is positioned substantially perpendicular to the flow direction of the gas 2. Where a multiplicity of nozzles is used the liquid 9 flows preferably do not interfere so as to obtain and optimum contact of liquid 9 and gas 2. According to an alternative embodiment the liquid 9 may be injected at an angle with respect to the gas flow direction, i.e. an angle different from perpendicularly, for example an angle of up to 45°.

The injected liquid 9 is preferably injected with sufficient force to obtain an even jet of liquid 9 along the total cross-sectional area of the space 8. Such ensures an optimum contact and a most efficient cleaning.

The gas cleaning compartment 4, more in particular the space 8 where the piqued is injected, extends until further than the radial dimension of the gas conduit 3. As a consequence, the liquid 9 may flow away without entering the gas conduits 3, when it hits the wall 10 of the gas cleaning compartment 4. Such solution for removal of used liquid 9 is also effective when the gas conduit 3 and the gas cleaning compartment 4 are positioned horizontally, instead of vertically as shown in the figure. Thus, the device 1 comprises a liquid collection device 11 for collecting used liquid 9. Form thereon, the liquid may be dispensed of towards a reservoir 12 for cleaning or reprocessing.

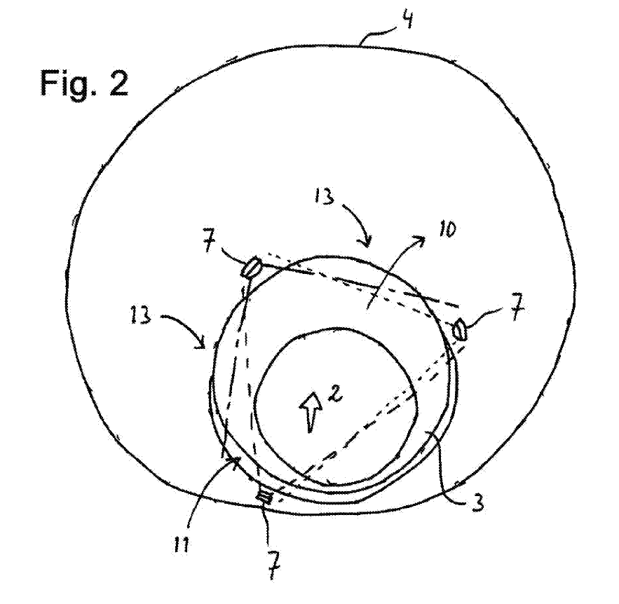

FIG. 2 gives a schematic perspective view of the device 1. The gas conduit 3 and the gas cleaning compartment 4 can be clearly seen. Furthermore, three burner nozzles 6 are shown, which however are optional. The device 1 comprises three nozzles 7 for liquid, that together cover the gas flow area so as to efficiently treat and clean the gas 2. The covered area is schematically identified by dotted lines. The used liquid flows away through space 13 between the gas conduit 3 and the wall 10 of the gas cleaning compartment 4.

A test experiment was performed as follows. An amount of gas to be cleaned of 1 m3/sec was fed though a gas conduit with an inner diameter of 20 cm. The gas cleaning compartment has an inner diameter of 25 cm. The gas cleaning compartment comprises three Steinen (trademark) water nozzles each providing a throughput of about 12 l/hr at a pressure of 20 psi. The spray angle of the nozzles is about 60°.

According to a first experiment, the water comprised tap water without any additives. A second experiment was performed with water comprising a slight addition of CaCO₃ for neutralizing any small amount of acid components in the gas. The gas to be cleaned comprised, among others, NO₂ and SO₂.

### EXPERIMENT I

Concentrations of NO₂ and SO₂ were reduced to below the measuring limitations of the measuring equipment. Solid particles present in the gas were not visible by the eye and were all removed by the water.

Without any addition of water in the gas cleaning compartment the concentrations amounted NO₂ 57 ppm and SO₂ 250 ppm.

When injecting liquid into the gas cleaning compartment the concentrations of NO₂ and SO₂ were not detectable.

The liquid's pH was substantially lower after having performed the test experiment, from pH 7 to pH<5.

### EXPERIMENT II

Concentrations of NO₂ and SO₂ were reduced to below the. The amount of solid particles present in the gas were reduced substantially on the eye, after treatment of the gas with the liquid and were not visible anymore, thus the solid particles were removed by the water.

Without addition of any liquid into the gas cleaning compartment the concentration amounted to NO₂ 57 ppm and SO₂ 250 ppm.

When injecting a liquid comprising CaCO₃ into the gas cleaning compartment the concentrations of NO₂ and SO₂ were not detectable.

The pH of the liquid after the treatment was substantially reduced from pH 9 to about pH 7. The addition of CaCO₃ to the liquid had no noticeably influence on the removal of harmful substances but yielded a liquid flow that could be disposed of without any further processing.

### EXPERIMENT III

A further embodiment of the invention provides for a combination of the invention with an additional burner at a position upstream the gas cleaning compartment 4. Preferably, a burner using HHO is used.

It has shown that such HHO burner has a positive influence on the removal of solid particles in the gas. On the eye, the solid particles that are present in the gas are completely removed after treatment of the gas with the HHO burner and the liquid and are thus fully removed.

In the test three nozzle burners were used of the kind Delavan Siphon nr. 4 (trademark), with the addition of HHO in an amount of 10 l/min.

The burners increased the amount of NOx in the gas to be cleaned, but this was removed from the gas by means of the liquid treatment according to the invention to a value less than detectable.

The device according to the present invention can be used suitably for cleaning gasses that comprise a large amount of solid particles. Examples thereof are flue gasses from diesel engines, especially ships diesel engines. Also, cleaning of flue gasses from power plants, amongst which coal fired and gas fired power plants, and municipal waste incinerators can be performed suitably with the device according to the present invention. All solid particles, like fly ash, are removed efficiently and effectively with the device and method according to the present invention. Furthermore, water soluble substances like sulfur oxides are affectively removed. Thus, the treated gasses can be discharge into the environment directly without any after treatment thereof.

The invention is not limited to the embodiments as described above and as shown in the drawing. The invention is limited only by the appending claims.

The invention also covers all combinations of features and measures that are described in this text independently of each other.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

1. A method for cleaning a gas, comprising the step of guiding said gas to be cleaned through a gas cleaning compartment and contacting said gas with a liquid, the method comprising the further step of injecting the liquid into a gas flow under pressure over a complete flow area of said gas cleaning compartment for capturing contaminants from said gas flow;
characterized in that:
the gas to be cleaned is fed into the gas cleaning compartment from a gas supply line, said gas cleaning compartment having a peripheral wall, and in that the gas cleaning compartment at a downstream position of the gas supply line is provided with at least one injection nozzle provided in the peripheral wall for injecting the liquid into the gas cleaning compartment and against an opposite wall part,
said method further comprising the step of discharging the liquid and the contaminants contained therein via the peripheral wall of the gas cleaning compartment.

2. The method according to claim 1, comprising the step of injecting the liquid through a slit-shaped nozzle.

3. The method according to claim 1, comprising the step of injecting the liquid through at least two nozzles that are divided along the circumference of the peripheral wall of the gas cleaning compartment.

4. The method according to claim 1, comprising the step of injecting the liquid in at least two layers that substantially completely cover the complete flow area of the gas cleaning compartment.

5. The method according to claim 4, wherein each layer comprises at least one nozzle.

6. The method according to claim 1, wherein the liquid comprises water.

7. The method according to claim 1, wherein the gas supply line has a first diameter and the gas cleaning compartment has a second diameter, wherein the second diameter is larger than the first diameter.

8. The method according to claim 1, comprising the step of vertically in an upward direction feeding the gas to be cleaned through the gas cleaning compartment.

9. The method according to claim 1, comprising the step of feeding the gas to be cleaned through the gas supply line in a direction other than a vertical direction and injecting the liquid into the gas cleaning compartment for contacting the gas flow with the liquid and discharging the liquid via the peripheral wall of the gas cleaning compartment.

10. The method according to claim 1, wherein part of the gas supply line that is positioned inside the gas cleaning compartment as well as the gas cleaning compartment itself are coaxial tubular shapes, wherein the liquid is discharged via an interstitial space between said coaxial tubular shapes.

11. A device for performing a method according to claim 1, comprising a gas cleaning compartment with a gas supply line for feeding a gas to be cleaned into the gas cleaning compartment, said gas cleaning compartment being provided with at least one nozzle for injecting into the gas cleaning compartment a liquid for contacting the gas to be cleaned with the liquid, wherein the device further comprises a discharge for discharging the injected liquid.

12. A device according to claim 11, wherein the gas supply line for feeding the gas to be cleaned has a first diameter, said gas supply line debouching into a gas cleaning compartment with a second diameter, said second diameter being larger than the first diameter, and wherein the device is provided with a nozzle for injecting into the gas cleaning compartment a liquid, wherein the gas cleaning compartment has a wall that extends at least radially outside the gas supply line.
